(19) United States
(12) Patent Application Publication
(10) Pub. No.: US 2009/0230183 A1
(43) Pub. Date: Sep. 17, 2009

(54) POLARIZING OPTICAL ELEMENT AND METHOD OF MAKING THE SAME

(75) Inventor: Susumu IIDA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/271,029

(22) Filed: Nov. 14, 2008

(30) Foreign Application Priority Data
Mar. 14, 2008 (JP) 2008-065515

(51) Int. Cl. G07F 19/00; B05D 5/06; G02B 5/30

(52) U.S. Cl. 235/379; 427/163.1; 359/485

(57) ABSTRACT

A reactive resin thin film is formed on the surface of a substrate. Parallel bars, lying on the surface of the reactive resin thin film, are urged against the surface of the substrate so as to establish strips of film made of a reactive resin between the adjacent ones of the parallel bars. The strips of film are cured. The thickness of the strips of film can be adjusted in a facilitated manner. An optically impermeable film is formed on the surface of the substrate to cover over the strips of film. The surface of the substrate is subjected to polishing process along a plane parallel to the surface of the substrate so that the strips of film and strips of the optically impermeable film alternately arranged are exposed along the plane. The polarizing optical element can be produced without dry etching.

### CROSS-REFERENCE TO RELATED APPLICATION

This application is based upon and claims the benefit of priority from the prior Japanese Patent Application No. 2008-65515 filed on Mar. 14, 2008, the entire contents of which are incorporated herein by reference.

### BACKGROUND OF THE INVENTION

1. Field of the Invention

The present invention relates to a polarizing optical element incorporated in an image capturing apparatus, for example.

2. Description of the Prior Art

A polarizing optical element is well known as disclosed in Japanese Laid-open Patent Publication Nos. 2004-271558 and 2006-201540. A resist film is formed on a glass substrate in the production of the polarizing optical element, for example. Nanoimprint is employed to transfer a predetermined pattern to the resist film. The resist film is patterned in a predetermined contour. The glass substrate is then subjected to dry etching. The glass substrate is carved out at a position outside the resist film. Parallel grooves are formed on the surface of the glass substrate, for example. An aluminum film is formed on the surface of the glass substrate so infill the grooves after the resist film has been removed. The aluminum film is thereafter removed from the surface of the glass substrate. Strips of film made of aluminum are thus formed in the grooves of the glass substrate. The polarizing optical element is in this manner produced.

In such a conventional method, expensive equipment is necessary for dry etching. It is not easy to utilize such equipment for dry etching. In addition, chlorine gas, which is harmful for people and the environment, is utilized for dry etching. If the thickness of the resist film is not constant, residue of the resist film remains on the surface of the glass substrate between the strips of resist film. The surface of the glass substrate cannot thus be subjected to dry etching. It is required to adjust the thickness of the resist film based on high technique to prevent generation of the residue.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### SUMMARY OF THE INVENTION

It is accordingly an object of the present invention to provide a polarizing optical element and a method of making the same, allowing a simplified production process without dry etching.

According to a first aspect of the present invention, there is provided a method of making a polarizing optical element, comprising: forming a reactive resin thin film on the surface of a substrate; urging parallel bars, lying on the surface of the reactive resin thin film, against the surface of the substrate so as to establish strips of film made of a reactive resin between the adjacent ones of the parallel bars; curing the strips of film; forming an optically impermeable film on the surface of the substrate to cover over the strips of film; and applying polishing process along a plane parallel to the surface of the substrate so that the strips of film and strips of the optically impermeable film alternately arranged are exposed along the plane.

The parallel bars are urged against the surface of the substrate in the method. As a result, the strips of film made of a reactive resin are formed between the adjacent ones of the parallel bars. The thickness of the strips of film can be adjusted in a facilitated manner. The optically impermeable film is formed on the surface of the substrate to cover over the strips of film. The strips of film and the strips of optically impermeable film are thus alternately arranged. The polarizing optical element can be produced without dry etching, for example. The production process of the polarizing optical element can be simplified. The production cost of the polarizing optical element can be reduced.

The refractive index of the strips of film is set equal to the refractive index of the substrate after the cure of the strips of film in the method. Moreover, the method allows employment of a reactive resin thin film made of one of a light curable resin and a thermosetting resin. The polarizing optical element is incorporated in an authenticating unit, for example. The authenticating unit is incorporated in an automatic transaction machine, for example.

According to a second aspect of the present invention, there is provided a polarizing optical element comprising: a glass substrate having optical permeability; strips of resin film having optical permeability, the strips of resin film arranged on the surface of the substrate; and strips of optically impermeable film formed on the surface of the substrate at positions between the adjacent ones of the strips of resin film. The polarizing optical element of this type can be produced in a relatively facilitated manner based on the aforementioned method. The production process of the polarizing optical element can be simplified. The production cost of the polarizing optical element can be reduced.

The refractive index of the glass substrate is set equal to that of the strips of resin film in the polarizing optical element. The strips of resin film are made of one of a light curable resin and a thermosetting resin.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating an automatic teller machine as a specific example of an automatic transaction machine according to the present invention;

FIG. 2 is a sectional view schematically illustrating the structure of an image capturing apparatus incorporated in an authenticating unit according to the present invention;

FIG. 3 is an exploded view schematically illustrating the image capturing apparatus;

FIG. 4 is a perspective view schematically illustrating a polarizing optical element according to an embodiment of the present invention;

FIG. 5 is a perspective view schematically illustrating a substrate prepared for producing the polarizing optical element;

FIG. 6 is a perspective view schematically illustrating a process of forming a reactive resin thin film on the surface of the substrate;

FIG. 7 is a perspective view schematically illustrating a process of forming a reactive resin thin film on the surface of the substrate;

FIG. 8 is a perspective view schematically illustrating a process of urging parallel bars against the surface of the substrate;

FIG. 9 is a perspective view schematically illustrating a process of forming strips of films made of a reactive resin on the surface of the substrate; and

FIG. 10 is a perspective view schematically illustrating substrate covered with an aluminum film prior to application of polishing process.

### DESCRIPTION OF THE PREFERRED EMBODIMENT

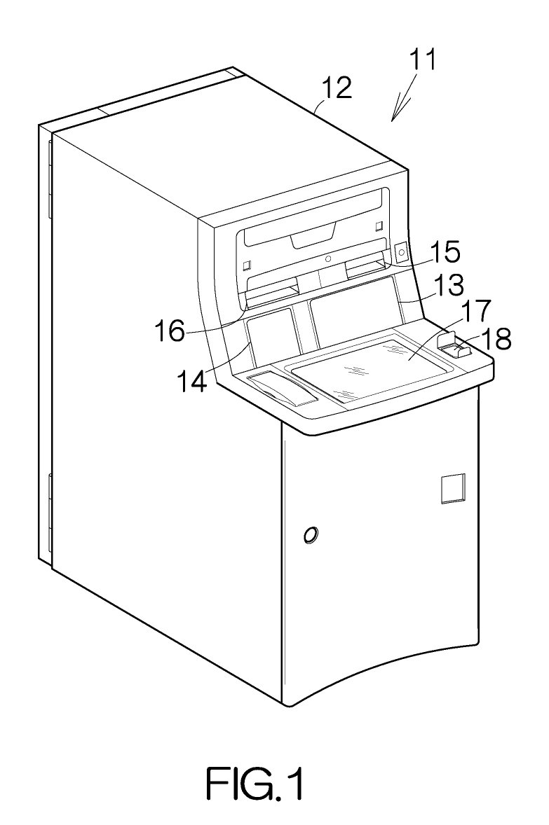

FIG. 1 schematically illustrates an automatic teller machine (ATM) 11 as a specific example of an automatic transaction machine. The ATM 11 allows various kinds of transactions such as withdrawal of cash, deposit of cash to own account, deposit of cash to other's account, transfer, and the like. The ATM 11 includes a box-shaped enclosure 12. A bill opening 13 and a coin opening 14 are formed in the front of the enclosure 12. An opening/closing cover is attached to close each of the bill opening 13 and the coin opening 14. A user puts/takes bills and coins in/out of the bill opening 13 and the coin opening 14, respectively, for withdrawal/deposit of cash or transfer.

A card slot 15 and a passbook slot 16 are formed in the front of the enclosure 12. The card slot 15 is designed to receive a plastic ATM card with a magnetic stripe or plastic smartcard with a chip for various kinds of transactions, for example. The passbook slot 16 is likewise designed to receive a passbook. Transactions are recorded in the received passbook. An input device, namely a touch screen panel 17, is also incorporated in the enclosure 12 for various kinds of transactions. Key buttons for options, ten keys, character or alphabetical keys are displayed on the screen of the touch screen panel 17, for example. When the key buttons, the ten keys and the character keys are touched on the surface of the touch screen panel 17, corresponding processings, numerals and characters are input into the ATM 11.

An authenticating unit 18 is incorporated in the front of the enclosure 12 at a position adjacent to the touch screen panel 17. The authenticating unit 18 is utilized for personal authentication of a user of the ATM 11. The authenticating unit 18 includes an image capturing apparatus. The image capturing apparatus will be described later. The image capturing apparatus is designed to capture the image of the veins of the user's palm. Biometric authentication software, incorporated in the ATM 11, is executed for personal authentication. The biometric authentication software is stored in a storage apparatus, for example. In the biometric authentication software, the data of the captured image of the veins is compared with the data of the pre-registered image of the veins so as to detect similarity and difference in characteristics between these two images.

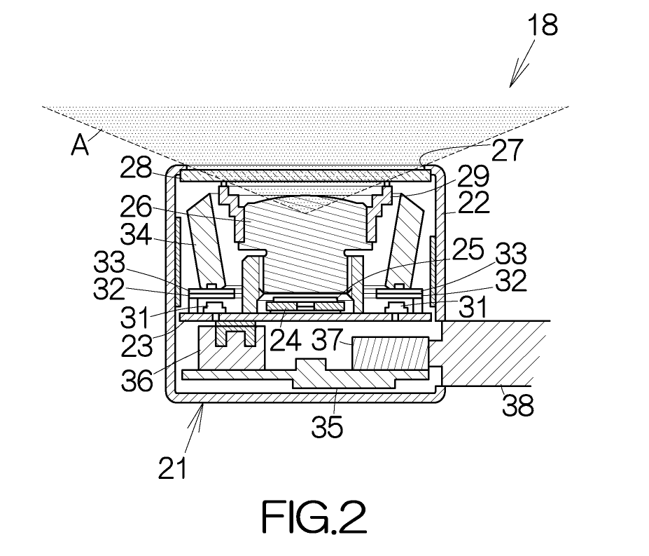

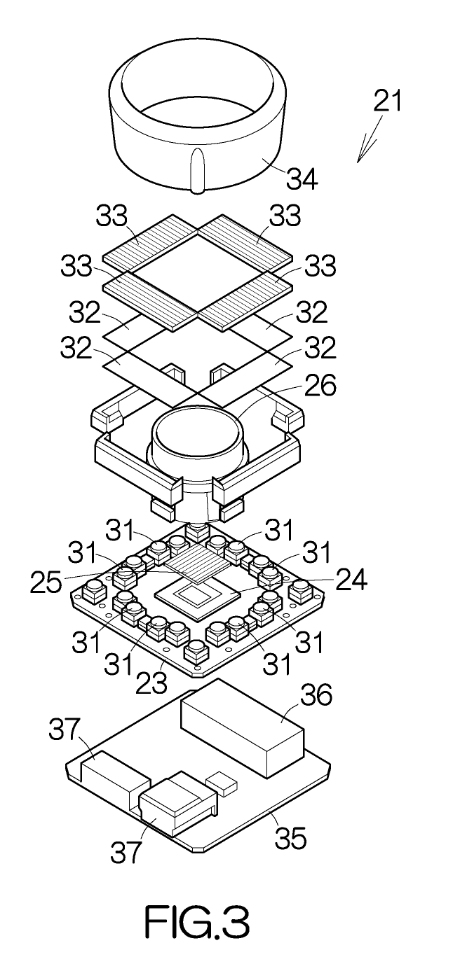

FIG. 2 schematically illustrates an image capturing apparatus 21 incorporated in the authenticating unit 18. The image capturing apparatus 21 includes a box-shaped casing 22. A first substrate 32 for a camera board is incorporated in the casing 22. Referring also to FIG. 3, an image sensor 24 is mounted on the first substrate 23. The image sensor 24 is a CMOS (complementary metal-oxide semiconductor) image sensor, for example. The image sensor 24 is designed to detect an image based on the amount of light received at each pixel. A polarizing optical element 25 is placed on the image sensor 24. The polarizing optical element 25 is designed to convert light led to the image sensor 24 into a light beam having linear polarization. The polarizing optical element 25 will be described later in detail.

An optical unit 26 is placed on the image sensor 24 on the surface of the first substrate 23. A lens optical system such as a collective lens is incorporated in the optical unit 26. The optical unit 26 is opposed to an opening 27 formed in the top plate of the casing 22. A visible light cut filter 28 is fitted in the opening 27. The visible light cut filter 28 serves to prevent visible light or spectrum from entering the casing 22 through the opening 27 toward the optical unit 26. A stepped cylindrical hood 29 is attached to the optical unit 26, for example. The hood 29 serves to prevent unintended light from entering the optical unit 26 from the outside of a predetermined range.

Light-emitting elements 31 are mounted on the surface of the first substrate 23 at the periphery of the optical unit 26. The light-emitting elements 31 output near-infrared light toward the opening 27. Diffusers 32 and polarizing optical elements 33 are placed on the surface of the first substrate 23. The polarizing optical elements 33 are designed to convert the near-infrared light output from the light-emitting elements 31 into a light beam having linear polarization. A cylindrical light guiding body 34 is placed on the polarizing optical elements 33, for example. The cylindrical light guiding body 34 serves to lead the near-infrared light output from the light-emitting elements 31 to the outer space through the opening 27. In this manner, the near-infrared light is radiated to a predetermined image capturing area A in the outer space at a uniform intensity through the opening 27. Each of the polarizing optical elements 33 has the structure identical to the structure of the aforementioned polarizing element 25.

A second substrate 35 for a controller circuit board is enclosed in the casing 22 at a position behind the first substrate 23. The second substrate 35 is electrically connected to the first substrate 23 through a first connector 36. A second connector 37 is mounted on the second substrate 35 for connection to external devices. The second substrate 35 is electrically connected to a motherboard, not shown, incorporated in the ATM 11 through the second connector 37, for example. A cable 38 may be coupled to the second connector 37 on the second substrate 35 for connection to the motherboard, for example. The operation of the image capturing apparatus 21 can thus be controlled. Simultaneously, data specifying the image of veins, captured by the image capturing apparatus 21, can be output to the motherboard.

Now, assume that personal authentication is executed in the authenticating unit 18 of the ATM 11. The user's palm is set above the opening 27. The light-emitting elements 31 output near-infrared light. The near-infrared light is radiated to the palm from the opening 27 through the light guiding body 34. As conventionally known, near-infrared light is absorbed into hemoglobin in red blood cells flowing in veins. A distribution of intensity is thus generated in the near-infrared light reflected from the palm. The reflected near-infrared light is led into the image sensor 24 through the optical unit 26. The image sensor 24 outputs image data of the veins to the motherboard. The captured image data of the veins is compared with the pre-registered image data. Personal authentication is in this manner executed.

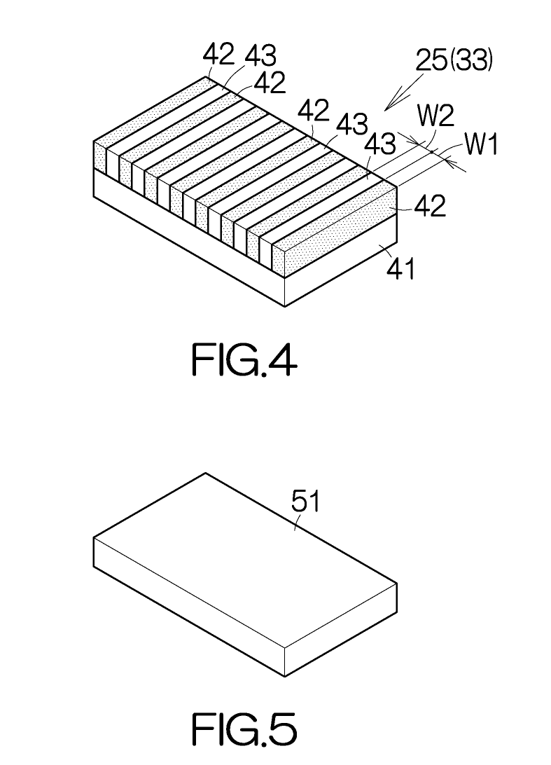

FIG. 4 schematically illustrates the polarizing optical element 25, 33 according to an embodiment of the present invention. The polarizing optical element 25, 33 includes a substrate 41 in the shape of a flat rectangular parallelepiped, for example. The substrate 41 is a glass substrate having optical permeability. Strips 42 of resin film are arranged in parallel with one another on the surface of the substrate 41. The individual strip 42 of resin film is formed in the shape of a bar having the rectangular cross-section set perpendicular to the longitudinal axis of the bar, for example. The bar is received on the surface of the substrate 41 at one of the parallel surfaces extending in parallel with the longitudinal axis. Light passes through the strips 42 of resin film. The refractive index of the strips 42 of resin film is set equal to that of the substrate 41. The strips 42 of resin film may be made of a light curable resin, for example. Here, the light curable resin is an ultraviolet curable resin such as “PAK-01®” produced by Toyo Gosei Co., Ltd., for example.

Strips 43 of optically impermeable film are formed on the surface of the substrate 41 at positions between the adjacent ones of the strips 42 of resin film. The strips 42 of resin film and the strips 43 of optically impermeable film are alternately arranged on the surface of the substrate 41. The individual strip 43 of optically impermeable film is formed in the shape of a rectangular bar in the same manner as the strip 42 of resin film, for example. Light cannot pass through the strips 43 of optically impermeable film. The strips 43 of optically impermeable film are made of a metal material such as aluminum, for example. Alternatively, the strips 43 of optically impermeable film may be made of one of metal materials such as tungsten, copper, gold, silver, nickel, titanium and chromium. The polarizing optical element 25, 33 allows the near-infrared light to pass through the strips 42 of resin film while the near-infrared light is absorbed in the strips 43 of optically impermeable film. The near-infrared light is thus converted into a light beam having linear polarization through the polarizing optical elements 25, 33.

Each of the polarizing optical elements 25, 33 has the rectangular outline along the periphery of the substrate 41. The outline has the dimension (long side×short side) 7 [mm]×5 [mm] or 10 [mm]×6 [mm], for example. A width W1 of the individual strip 42 of resin film, defined along the long side of the substrate 41, is set at 80 nm approximately, for example. Likewise, a width W2 of the individual strip 43 of optically impermeable film, defined along the long side of the substrate 41, is set at 60 nm approximately, for example. The thicknesses of the strips 42, 43 of resin film 42 and optically impermeable film, measured in the vertical direction perpendicular to the surface of the substrate 41, are set at 150 nm approximately, for example.

Next, description will be made on a method of making the polarizing optical elements 25, 33. As shown in FIG. 5, a substrate 51 of a flat rectangular parallelepiped is prepared, for example. The dimension of the substrate 51 is sufficiently large so that two or more substrates 41 are cut out of the substrate 51, for example. The substrate 51 is made of glass. A light curable resin is applied to the front surface of the substrate 51. A reactive or curable resin thin film 52 is in this manner formed on the front surface of the substrate 51, as shown in FIG. 6. The light curable resin is the aforementioned ultraviolet curable resin such as “PAK-01®”. The thickness of the reactive resin thin film 52 is set at 150 nm approximately, for example.

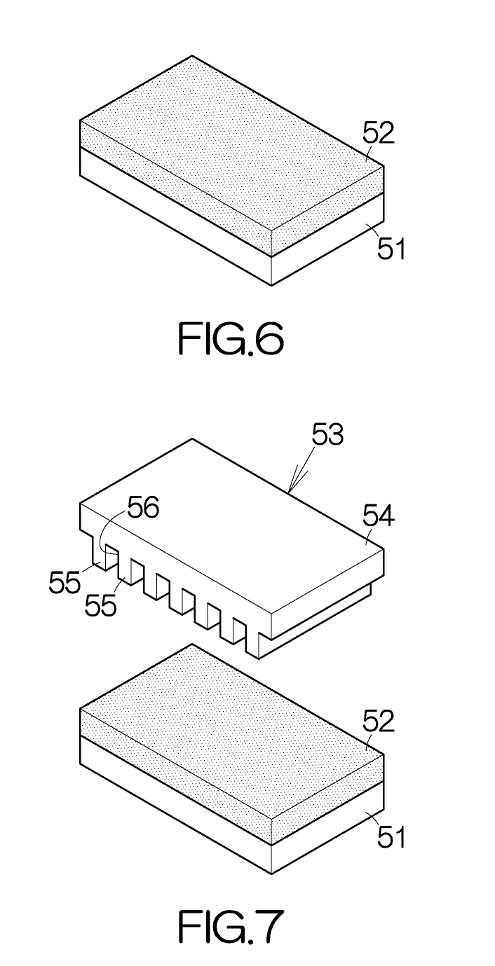

As shown in FIG. 7, a stamper 53 is prepared. The stamper 53 includes a main body 54 of a flat rectangular parallelepiped, for example. The lower surface of the main body 54 is a flat surface. A transfer pattern, namely parallel bars 55, is formed integral with the lower surface of the main body 54. The individual parallel bar 55 has the rectangular cross-section set perpendicular to the longitudinal axis of the bar. The bar is received on the main body 54 at one of the parallel surfaces extending in parallel with the longitudinal axis. Grooves 56 are defined between the respective adjacent ones of the parallel bars 55. The exposed or top surfaces of the parallel bars 55, extending in parallel with the flat lower surface of the main body 54, are defined within a plane. The outline of the parallel bar 55 corresponds to that of the strip 43 of optically impermeable film. The outline of the groove 56 corresponds to that of the strip 42 of resin film. The stamper 53 may be an electroformed stamper made of a metal material, for example.

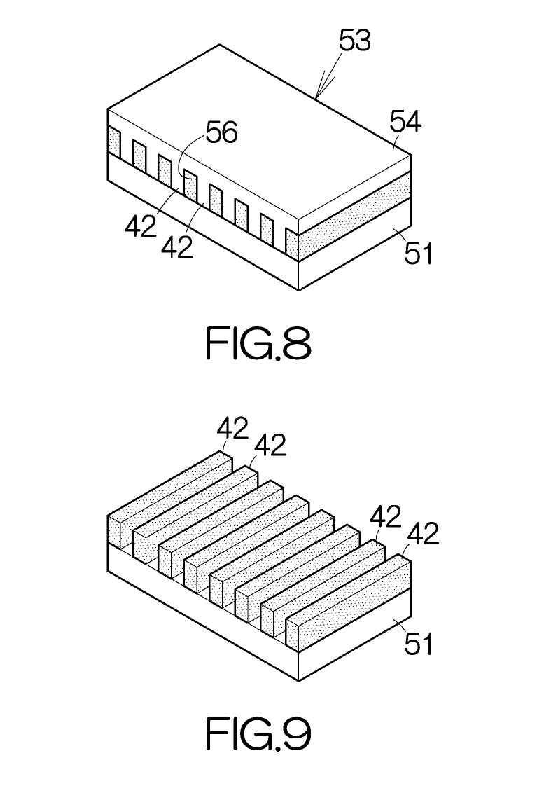

As shown in FIG. 8, the stamper 53 is urged against the front surface of the substrate 51. So-called nanoimprint is executed. The top surfaces of the parallel bars 55 are brought in close contact with the front surface of the substrate 51 after having laid on the surface of the reactive resin thin film 52. The reactive resin thin film 52 is forced to run into the grooves 56 of the stamper 53. The strips 42 of resin film, made of a reactive resin, are in this manner formed between the adjacent ones of the parallel bars 55. Ultraviolet rays are then radiated to the substrate 51 from the backside of the substrate 51, for example. The ultraviolet rays serve to cure the strips 42 of resin film between the adjacent ones of the parallel bars 55. The stamper 53 is then removed from the substrate 51. The strips 42 of resin film are in this manner formed on the front surface of the substrate 51, as shown in FIG. 9.

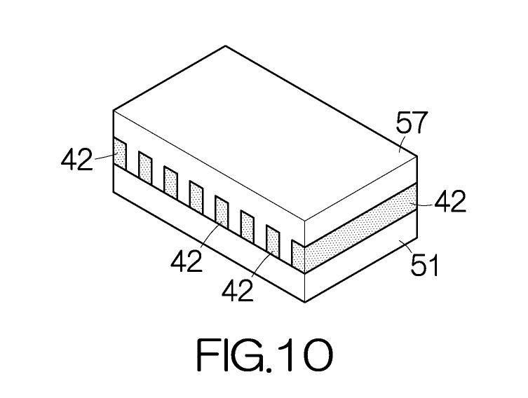

Aluminum is sputtered onto the front surface of the substrate 51, as shown in FIG. 10. An optically impermeable film 57 is thus formed on the front surface of the substrate 51. The optically impermeable film 57 covers over the strips 42 of resin film. Spaced between the adjacent ones of the strips 42 of resin film are filled with a part of the optically impermeable film 57. Polishing process is then applied to the optically impermeable film 57 along a plane parallel to the front surface of the substrate 51 from the upper or exposed widest surface thereof. The polishing process may be chemical-mechanical polishing (CMP), for example. The strips 42 of resin film and the strips 43 of optically impermeable film, which are alternately arranged, are thus exposed along the aforementioned plane, as shown in FIG. 4. Subsequently, the polarizing optical elements 25, 33 may be cut out.

In the polarizing optical elements 25, 33, the strips 42 of resin film and the strips 43 of optically impermeable film are alternately arranged on the surface of the substrate 41. The strips 42 of resin film are formed on the surface of the substrate 41 based on nanoimprint. The thickness of the strips 42 of resin film can be adjusted in a facilitated manner. In addition, sputtering is employed to form the strips 43 of optically impermeable film between the adjacent ones of the strips 42 of resin film, for example. The polarizing optical elements 25, 33 can be produced without dry etching. The production process of the polarizing optical elements 25, 33 can be simplified. The production cost of the polarizing optical elements 25, 33 can be reduced.

A laser beam such as an electron beam (EB), a focused ion beam (FIB), or the like, may be radiated to the reactive resin thin film 52, in place of employment of the stamper 53, for forming the strips 42 of resin film. The reactive resin thin film 52 is exposed to the laser beam within a restricted area. The reactive resin thin film 52 is thus cured or hardened based on the exposure. The reactive curable resin thin film 52 is uncured over the unexposed area around the exposed restricted area. The uncured portion of the reactive resin thin film 52 is removed. The strips 42 of resin film are in this manner formed out of the reactive resin thin film 52. The stamper 53 may be made of a material having optical permeability. Ultraviolet rays may be radiated to the substrate 51 behind the stamper 53.

In the polarizing optical elements 25, 33, the strips 42 of resin film may be made of a reactive resin such as thermosetting resin in place of the aforementioned light curable resin. Here, the thermosetting resin may be a resin preferably utilized for an insulating interlayer in a printed circuit board or the like. Such a resin includes polymethylmethacrylate (PMMA) and “HSG-255®” produced by Hitachi Chemical Company, Ltd., for example. The strips 42 made of the thermosetting resin have optical permeability in the same manner as described above. Likewise, the refractive index of the strips 42 made of the thermosetting resin is set equal to that of the substrate 41.

Thermosetting resin in liquid state is applied to the front surface of the substrate 51 for the production of the polarizing optical elements 25, 33. The reactive resin thin film 52 is in this manner formed on the front surface of the substrate 51. The stamper 53 is then urged against the front surface of the substrate 51 in the same manner as described above. Since the reactive resin thin film 52 is made of thermosetting resin, the thermosetting resin is cured or hardened between the adjacent ones of the parallel bars 55 in response to application of heat to the reactive resin thin film 52. A so-called hot embossing is executed. Subsequently, the aforementioned process may be executed.

The turn of the embodiments isn't a showing the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of making a polarizing optical element, comprising:
forming a reactive resin thin film on a surface of a substrate;
urging parallel bars, lying on a surface of the reactive resin thin film, against the surface of the substrate so as to establish strips of film made of a reactive resin between adjacent ones of the parallel bars;
curing the strips of film;
forming an optically impermeable film on the surface of the substrate to cover over the strips of film; and
applying polishing process along a plane parallel to the surface of the substrate so that the strips of film and strips of the optically impermeable film alternately arranged are exposed along the plane.

2. The method according to claim 1, wherein a refractive index of the strips of film is set equal to a refractive index of the substrate after cure of the strips of film.

3. The method according to claim 1, wherein the reactive resin thin film is made of one of a light curable resin and a thermosetting resin.

4. A polarizing optical element comprising:
a glass substrate having optical permeability;
strips of resin film having optical permeability, the strips of resin film arranged on a surface of the substrate; and
strips of optically impermeable film formed on the surface of the substrate at positions between adjacent ones of the strips of resin film.

5. The polarizing optical element according to claim 4, wherein a refractive index of the glass substrate is set equal to a refractive index of the strips of resin film.

6. The polarizing optical element according to claim 4, wherein the strips of resin film are made of one of a light curable resin and a thermosetting resin.

7. An authenticating unit including the polarizing optical element according to claim 4.

8. An automatic transaction machine including the authenticating unit according to claim 7.
